(19) United States
(12) Patent Application Publication
(10) Pub. No.: US 2009/0326133 A1
(43) Pub. Date: Dec. 31, 2009

(54) FIRE AND FLAME RETARDANT POLYMER COMPOSITES

(75) Inventors: Robert C. Daly, Greece, NY (US); Aaron Wagner, Rochester, NY (US)

Correspondence Address: BASCH & NICKERSON LLP, 1777 PENFIELD ROAD, PENFIELD, NY, 14526, US

(73) Assignee: NaturalNano Research, Inc., Pittsford, NY (US)

(21) Appl. No.: 12/126,035

(22) Filed: May 23, 2008

Related U.S. Application Data
(60) Provisional application No. 60/939,658, filed on May 23, 2007.

(51) Int. Cl. C09K 21/14; C09K 21/12

(52) U.S. Cl. 524/445; 252/601

(57) ABSTRACT

Disclosed are materials and processes for obtaining improved resistance to fire and flame for polymer composites, using a flame and fire retardant system comprising a tubular clay. Halloysite is an example of such a clay and it can be used either alone or in combination with other chemicals. The tubular clays are advantaged over common platy clays for this application in that they do not require large amounts of organic compatibilizers, which may degrade the properties of the composite or require tedious process steps. The tubular clay can function alone or synergistically with other flame retardants, particularly organic flame retardants.

This application claims priority from U.S. Provisional Application 60/939,658, for “FIRE AND FLAME RETARDANT POLYMER COMPOSITES,” by Daly et al., filed May 23, 2007, which is also hereby incorporated by reference it its entirety.

This application hereby incorporates by reference the teachings of co-pending patent applications: (i) U.S. application Ser. No. 11/469,128 for a “POLYMERIC COMPOSITE INCLUDING NANOPARTICLE FILLER,” filed Aug. 31, 2006, and claiming priority from Provisional Application 60/713,362 filed Sep. 2, 2005; (ii) U.S. application Ser. No. 11/531,459 for “RADIATION ABSORPTIVE COMPOSITES AND METHODS FOR PRODUCTION,” filed Sep. 13, 2006, and claiming priority from Provisional Application 60/717,533, filed Sep. 14, 2005; (iii) Provisional Application 60/867,369, filed Nov. 27, 2006; and (iv) U.S. application Ser. No. 11/697,510 for an “IMPROVED POLYMERIC COATINGS INCLUDING NANOPARTICLE FILLER,” filed Apr. 6, 2007.

Disclosed are materials and processes for obtaining improved resistance to fire and flame for polymer composites, and more particularly the use of a tubular clay in such composites to provide a flame and fire retardant system.

### BACKGROUND AND SUMMARY

Polymers of modern commerce are generally organic in nature, made predominantly of carbon, hydrogen, nitrogen and oxygen. Inherent in this composition is that these materials will burn when heated sufficiently or brought into contact with a flame. The resulting fire will, of course, destroy the polymer and damage the surroundings. Since the materials used to make cloth and many construction components are polymeric, the danger to life and property is apparent.

To address such problems, a wide array of additives have been developed for polymers; additives which retard ignition (fire retardants) or reduce the ability of the polymer mixture to continue burning when an external flame is applied and then removed (flame retardants). However, many of these additives cause or result in other disadvantages, including degradation of polymer physical properties, environmental impacts and processing difficulties.

Polymer composites, polymer matrices containing one or more fillers, represent an approach that has shown advantages for fire and flame retardance. When an inorganic filler is used to improve the physical performance of the polymer it is also non-flammable, and may have other properties that allow it to protect the polymer around it during combustion events. These properties might be heat dissipation, water release or production, or the formation of a protective char. Small filler particles provide large surface areas, and the surface area interactions produce a larger performance improvement than do large particles. The smallest particles have at least one dimension smaller than 1 micron and can be said to be nanoparticles which in turn produce a polymer nanocomposite. To be effective, the fillers must be used in sufficient amounts, reduced to the smallest possible particle size and must be dispersed completely within the polymer matrix.

One class of fillers which is used are clays. In one embodiment, clay particles are made up of sheets of various aluminosilicates. Most clays can be said to have a platy structure. That is the sheets are stacked one on top of another analogously to playing cards being stacked in a deck. The sheets are interactive and considerable energy or chemicals are required to allow a clay particle to be separated into the individual sheets. A few unusual clays can exist as tubes. In this case the clay particles already exist as individual sheets.

Dispersion of a traditional platy clay requires chemicals, which can cause problems for the performance of the polymer matrix and the fillers themselves may make polymer processing quite difficult. In the use of tubular clays, an advantage compared to platy clays is that there is no need to intercalate or exfoliate the clay. Therefore, little chemical treatment and few additional processes are required to maximize tubular clay dispersion and performance within the composite. Accordingly, the use of tubular clays as flame and fire retardant additives in polymer composites is believed to overcome some of the disadvantages of traditional platy clay additives.

The present disclosure contemplates the preparation of polymer nanocomposites that have improved fire and flame retardance produced by means of the use of easily dispersed halloysite clay filler particles. Halloysite is essentially a tubular aluminosilicate clay that provides fire and flame retardation and can improve the performance of other retardant chemicals and systems.

Formed objects made from fire and flame retardant polymer-halloysite nanocomposites can be fibers, sheets, foams, wire cladding, molded parts, etc. Halloysite containing nanocomposites can be extruded, coextruded or melt cast. Extruded or coextruded materials may be stretched uniaxially or biaxially. The nanocomposites can also be formulated as latexes or dispersions for coating applications such as paint and fiber or fabric treatment. The halloysite nanotubes can be dispersed in polymer solutions to produce solution based coating formulations or paints.

The following US patents and publications are hereby incorporated by reference in their entirety:

U.S. Pat. Nos. 4,434,075; 4,582,866; 4,889,885; 4,894,411; 5,385,776; 5,514,734; 5,651,976; 5,718,841; 5,747,560; 5,780,376; 5,952,093; 6,034,163; 6,036,765; 6,414,070; and 6,518,324.

J. W. Gilman, C. L. Jackson, A. B. Morgan, R. Harris, E. Manias, E. P. Giannelis, M. Wuthenow, D. Hilton and S. H. Philips; Chem. Mater., 12: 1866-1873 (2000).

M. Zanetti, T. Kashiwagi, L. Falqui, G. Camino; Chem. Mater., 14: 881-887 (2002).

M. Si, V. Zaitsev, M. Coldman, A. Frenkel, D. G. Peiffer, E. Weil, J. C. Sokolov, M. H. Rafailovich; Polymer Degradation and Stability, 92, 86-93 (2007).

M. Zanetti, G. Camino, C. Canavese, A. B. Morgan, F. G. Lamelas, C. A. Wilkie; Chem. Mater., 14.189-193 (2002).

Linda S. Birnbaum and Daniele F. Staskal; Environmental Health Perspectives, 112: 9-17 (2004).

G. J. vanEsch; World Health Organization; Flame Retardants: A General Introduction, Environmental Health Criteria 192, (1997).

M. A. Osman, M. Ploetze and U. W. Suter; J. Mater. Chem., 13, 2359-2366 (2003).

B. Arkles; Silane Coupling Agents: Connecting Across Boundaries; V2.0, copyright 2006.

Naturally occurring and man-made polymers have a broad array of physical, optical and chemical properties depending upon their source, the monomeric materials used to produce them; and the processes used to synthesize them and to make them into useful items. But, their performance can be further enhanced by the inclusion of appropriate additives. The additives can impact almost any property and some of the most frequent materials are; biocides, lubricants, antistats, fire retardants, flame retardants, etc. Inorganic materials can be added to improve the physical performance of the polymer system: elongation, toughness, break strength, dimensional stability, thermal stability, abrasion resistance, etc. Polymers may even be blended together (both compatible and incompatible blends) to optimize performance. If the particulate additives are dispersed as opposed to dissolved in the polymer, a composite is said to be formed. If the particles have at least one dimension that is submicron size then a nanocomposite has been formed.

Flame and fire retardance are particularly important for polymers because they are principally made of carbon, hydrogen, oxygen and nitrogen and therefore generally burn easily. Polymers requiring flame and fire retardance include most of the materials used for fibers, fillers, foams, adhesives, coatings, films, wire cladding, molded parts, etc., where there is the potential for personal or property damage from fire. This includes synthetic polymers and natural polymers. Synthetic examples include; polyesters, polyamides, polyurethanes, acrylic and methacrylic polymers and copolymers, styrenic polymers and copolymers, polylactic acid, polycarbonates, polyolefins (polyethylene, polypropylene, etc.), novolac resins, epoxy resins, melamine resins, synthetic rubbers, etc. Natural examples include; cellulose, cotton, wool, silk, starch, natural rubber, etc.

There are three basic ways that a material can act as a flame or fire retardant: 1) it releases vapors that are non-flammable, thereby diluting and disrupting the combustion of the vapors above the fuel; 2) it can interrupt the reaction mechanisms that produce the vapors that will burn or retard the release of the vapors from the fuel; and 3) it can form a protective, insulating coating during the initial phase of a burn, preventing the fire from getting to the remainder of the fuel.

While there are many types of fire and flame retardants, those used for polymers can generally be divided into just a few classes, including; halogenated organics (brominated or chlorinated), phosphorous containing organics, nitrogen containing organics and inorganics. Frequently, the complete retardant package will contain more than one of these chemicals from more than one of these classes to take advantage of the different mechanisms for fire suppression that are involved. A review of flame retardant technology including specific materials, uses and environmental issues is available online as part of the UN WHO series on Environmental Health Criteria (see e.g., G. J. vanEsch, World Health Organization; Flame Retardants: A General Introduction, Environmental Health Criteria 192, (1997)).

The brominated compounds are the most important of the organic flame and fire retardants because of their high performance efficiency, particularly when combined with synergistic inorganic compounds such as alumina trihydrate and antimony trioxide. They primarily inhibit the gas phase combustion. However, there are concerns about the toxicity of these compounds and they have become widely spread into the environment. (see e.g., Linda S. Birnbaum and Daniele F. Staskal; Environmental Health Perspectives, 112: 9-17 (2004)).

Most organic phosphorous-based fire and flame retardants are aryl or alkyl esters of phosphoric acid although analogous materials of phosphonic acid and polyphosphoric acid also work. These phosphorous-based materials primarily work in the condensed phase and assist the formation of char during burning. Organic structures containing phosphorous along with halogens or nitrogen have been shown to have an even higher effectiveness. Mixtures of the phosphate esters with highly halogenated compounds as mentioned above or with nitrogen compounds mentioned below also produce excellent results.

The nitrogen containing fire and flame retardants are generally based on melamine or guanidine compounds that can both disrupt vapor phase burning and participate in the formation of an intumescent crust.

The role of inorganic fire and flame retardants is as much physical as chemical. They dissipate heat, retard vapor movement in the polymer, release water when heated and remain as unburned material to protect the remaining polymer. Many of the inorganic materials are in fact rather ineffective by themselves. However, synergistically they make the organic retardants much more effective. Metal hydrates are the most common class of inorganics with aluminum hydroxide being the principle example. Boric acid works well in some polymers as do its sodium and zinc salts. Molybdenum, zinc and antimony compounds have some retardant effects but are used primarily as synergists with the organic retardants. Red phosphorous and ammonium polyphosphate represent the potential of the inorganic phosphorous flame retardants.

The use of platy clays as flame retardants has been reported (see e.g., J. W. Gilman, C. L. Jackson, A. B. Morgan, R. Harris, E. Manias, E. P. Giannelis, M. Wuthenow, D. Hilton and S. H. Philips; Chem. Mater., 12: 1866-1873 (2000)). Their mechanism for flame retardance is thought to be primarily the result of the exfoliated sheets forming a barrier for the migration of reactants out of the polymer composite. Newer work indicates that much of the flame and fire retardant effect of the platy clay comes about because it has very high surface areas which constrain the mobility of the polymer matrix near the surface of the clay. However, these platy clays must be exfoliated in order to produce high surface areas and to function effectively and this requires treatment with large amounts of organic compatibilizers. Composite systems using organically modified platy clays as components of flame retardant systems are documented, for example, in U.S. Pat. No. 4,434,075, U.S. Pat. No. 4,582,866, U.S. Pat. No. 5,718,814 and U.S. Pat. No. 6,414,070.

One aspect of the disclosed materials and processes contemplates the addition of halloysite clay to a polymer to produce a polymer composite, which provides improved fire and flame retardance for the composite without undesirable impacts. In particular, halloysite does not require the large amounts of organic additives, as much as 35% by weight, required to use a platy clay The addition of halloysite to polymer formulations, which already contain fire or flame retardant materials, produces a composite with further improved fire and flame retardance. A composite with halloysite or other clay nanotubes can synergistically improve the performance of the traditional flame and fire retardant system. Although it may be perceived that tubules or cylinders may be less desirable than sheets, the surface area available for interaction is still high. Furthermore, were there any disadvantage to this shape, it is believed that it is offset or outweighed by the lack of the large amounts of organics required to intercalate and exfoliate the platy clays, organics which impact the fire retardant characteristics of platy clay additives.

Disclosed in embodiments herein is a polymer composite comprising a polymer matrix and an inorganic filler, where the filler is a tubular clay and wherein the composite exhibits fire and flame retardant characteristics.

Further disclosed in embodiments herein is a fire and flame retardant polymer composite comprising: a polymer matrix, including a tubular clay filler; and a traditional polybrominated organic fire and flame retardant system, and processes for making and using the same.

Also disclosed in embodiments herein are a fire and flame retardant polymer composite comprising: a polymer matrix with a tubular clay filler in addition to a traditional phosphorous containing organic fire and flame retardant system, and processes for making and using the same.

Still further disclosed in embodiments herein are fire and flame retardant additives and materials, which in one embodiment include polymer composites, comprising a material (e.g., polymer) matrix with a tubular clay filler in addition to other inorganic materials used as flame and fire retardants in combination with traditional polybrominated organic or organophosphorous containing fire and flame retardant systems.

### DETAILED DESCRIPTION

As more particularly set forth below, the disclosed materials and processes are directed to composites that exhibit improved fire and flame retardant characteristics.

Platy clays can be used as additives for polymer composites and demonstrate positive impacts for improved physical properties and as flame and fire retardants. Clay is a generalized term for a broad array of minerals identified as hydrous aluminum phyllosilicates, which may have small amounts of impurities such as iron, magnesium, sodium, calcium, potassium, etc. Clays are produced by weathering other minerals such as feldspar and by low temperature hydrothermal processes. The general structure of clay minerals is a two dimensional sheet containing one or more layers of SiO₄ tetrahedra and one or more layers of AlO(OH)2 octahedra with a degree of oxygen sharing between the layers.

Major group classifications of clays include kaolinite, smectite and illite. Most clay minerals exist in a particulate form where the sheets are stacked like a deck of cards. A platy clay shall mean a layered or sheet-like inorganic clay material, such as a smectite or kaolinite clay in the form of a plurality of adjacent bound layers or sheets in a single clay particle, where each layer or sheet has both faces and edges, and where the vast majority of the individual clay layers or sheets terminate on the outer surface of the clay particle. Clays for use in composites must be physically broken into fine particles and separated from contaminating minerals.

To intimately disperse platy clays, the individual sheets must first be forced slightly apart (intercalation) and then separated completely (exfoliation). The modifications and processes used to produce the single sheets of clay and to disperse them homogeneously in the polymer composite often require large amounts of organics, which can degrade the very properties that are enhanced by the filler. The importance of fully separating the clay sheets was shown in experiments which prepared composites of dispersed clay particles and exfoliated clay in poly(ethylene-co-vinyl acetate) (PEVA). (see e.g., M. Zanetti, T. Kashiwagi, L. Falqui, G. Camino; Chem. Mater., 14: 881-887 (2002)). This corresponds to preparing micro- and nano-composites of clay in PEVA. The exfoliated nanocomposite dramatically reduced the rate of combustion of the EVA matrix while the microcomposite had little effect. A nanocomposite produced from polymethylmethacrylate (PMMA) and a platy clay formulated for dispersibility (Cloisite 20A, a natural montmorillonite modified with N,N-dimethyl di(dehydrogenated tallow) quaternary ammonium chloride, Southern Clay Products Inc.) was evaluated for flame and fire retardance with and without additional flame retardant additives (see e.g., M. Si, V. Zaitsev, M. Coldman, A. Frenkel, D. G. Peiffer, E. Weil, J. C. Sokolov, M. H. Rafailovich; Polymer Degradation and Stability, 92, 86-93 (2007)). When the clay was used with decabromo diphenyl oxide and antimony trioxide, a significant improvement in flame and fire retardancy was observed. However, the clay/PMMA composite actually caught fire faster that PMMA itself. The authors said that this was because of the excess surfactant on the clay which is known to ignite easily. Others have found similar ignition of the clay surfactant. (see e.g., M. Zanetti, G. Camino, C. Canavese, A. B. Morgan, F. G. Lamelas, C. A. Wilkie; Chem. Mater., 14.189-193 (2002)).

There are however, clay materials where the individual sheets are rolled into tube or scroll form rather than stacking flat. The tubes may be single wall or multiwall. The interior of the tube is called a lumen. Examples of this kind of clay include halloysite, imogolite, cylindrite, and boulongerite For clays like halloysite and imogolite, the sheet consists of an alumina face tied to a silica face. When the mineral is formed, one face will become the interior of the tube while the other will be the exterior. This differentiation of surface type and orientation is not seen with two dimensional nanoclays or other types of nanotubes. The fact that the tubes are rolled in a single orientation (silica in or out) means that the inside of the tube has a different surface chemistry when compared to the outside. Such a differential may be useful to perform selective chemistry or to confine or organize chemical agents within the tube, as opposed to on the exterior of the tube, or vice versa.

The edges of the halloysite nanotubes are indeed like the edges of regular clays, so that there will be a pH dependent edge charge that can be useful, and uniquely so if combined with the hollow nature or the inside/outside surface chemistry differential. For example, at a pH of less than the isoelectric point of the edges (about pH 6), the alumina terminated ends of the tube become positively charged, while the rolled sheet-like aluminosilicate surfaces remain negatively charged to their isoelectric point (a pH of about 2 for silica); in other words the aluminosilicate walls act as a polyvalent anion, while the ends of the tubes are amphoteric. Differential surface charges also open up an opportunity to do selective chemistry to confine or organize chemical agents within one area of the tube.

Halloysite nanotubes typically range in length from about 100 nm to 10,000 nm (10 microns), with an average (dependent on the natural source) of about 1,200 nm. In one embodiment, the nanocomposite material includes halloysite nanoparticles having a cylindrical length of about 100 nm to about 6,000 nm, with an average of approximately 1,200 nm. Inner diameters of halloysite nanotubes range from about 10 nm up to about 200 nm with an average of approximately 40 nm, while outer diameters range from about 20 nm to about 500 nm with an average of approximately 100 nm. In one embodiment, the nanocomposite material includes halloysite nanoparticles having an average outer cylindrical diameter of less than about 500 nm. It is also possible to characterize the halloysite nanotubes using a relationship between certain dimensions, i.e., an aspect ratio, e.g., length divided by diameter. In one embodiment it is believed that halloysite nanotubes may exhibit a length/diameter ratio of between about 0.2 and 250, with an average aspect ratio of about 12.

Native halloysite, a member of the kaolin family of clays, is a hydrated clay with an intercalated water layer giving a basal spacing of about 10 Å. Subsequent drying of the clay can lead to the dehydrated form of the clay where the intercalated water has been driven off and the basal spacing reduced to 7 Å. Hydrated and dehydrated halloysite can be distinguished through X-ray diffraction. Dehydration is a naturally irreversible process, though researchers have had some success with artificially rehydrating the tubes with a potassium acetate treatment. In the hydrated form the intercalated water can be substituted out by small alcohols such as glycerol. Halloysite may also contain small amounts of small cations such as sodium, potassium, calcium which can be exchanged with other ions or displaced with quaternary ammonium cations, for example benzalkonium chloride.

Although these tubular clays are much more easily dispersed than are platy clays, some treatment may be useful. Treatment of a halloysite nanotube clay by the appropriate compatibilizing agents is accomplished by any known method, such as those discussed in U.S. Pat. Nos. 4,889,885; 5,385,776; 5,747,560; and 6,034,163, which are also hereby incorporated by reference in their entirety. The amount of compatibilizing agent can vary substantially provided that the amount is effective to compatibilize the nanotubes to obtain a desired, and substantially uniform, dispersion. Further examples of various types of compatibilizing agents that may be useful for treating clays and other inorganic materials having nanotubular structures are found in the disclosures of U.S. Pat. Nos. 4,894,411; 5,514,734; 5,780,376; 6,036,765; and 5,952,093, which are hereby incorporated by reference in their entirety for their teachings.

The external surface of the tubular clay filler can interact with the other components of the composite in the normal manner of a clay surface. However, the tubular interior may also be filled. The interior volume of the tube may be referred to as the lumen and provides a unique space that can be filled. A small molecule contained within the lumen could have dramatically different availability than the same material within the bulk of the composite. This use of the clay tubes as a location for an eluate is described in U.S. Pat. No. 5,651,976 by Price et al., which is hereby incorporated by reference in its entirety. The lumen of the clay nanotubes could be advantaged to facilitate release of the material over time or a release during an event like heating (flame retardant, etc.). In regard to a fire or flame retardant, the heat of a fire could trigger the release of the chemical from within the tube only when it is needed.

Platy clays have demonstrated good performance as flame retardants in polymer composites within limits and have shown synergistic advantage with brominated organic flame and fire retardant systems. However, their effectiveness is reduced by the large amounts of organic material required to make them compatible with polymers. The processes used to make the finished polymer composite are also much more difficult in the presence of the large amount of organic compatibilizer required for the platy clay. Furthermore, the desired physical or chemical properties of the polymer may be degraded by the compatibilizer(s).

On the other hand, a major feature of tubular clays is that these materials can be readily dispersed, without the large amounts of chemicals and the unusual processes required to exfoliate and intercalate the platy clay. A tubular clay, such as halloysite, requires little if any organic compatibilization and can be readily processed into polymer composites with many common polymers. If compatibilization is required, about 0.5% of a benzalkonium chloride (or for example about 0.1%-2.0% or slightly higher) is sufficient compared to more than 30% for platy clays. Alternately, treatment with about 1% of alkoxy silanes, chlorosilanes or silazanes or reactive titanatex modifies the surface for dispersion into polymers. The addition of the halloysite directly reduces the ignition of the composite and retards or extinguishes burning after a flame source is removed. This latter characteristic may be demonstrated, for example, by the cone calorimetry experiment, wherein a composite having halloysite in the range of about 5 wt % to about 30 wt % exhibits improved retardance versus the polymer alone and versus a platy clay-polymer composite.

Similarly demonstrated is the improvement obtained by adding the halloysite to a polymer containing a conventional polybrominated or phosphorous organic flame retardant system. Accordingly, retardants may include; halogenated organics (brominated or chlorinated), phosphorous containing organics, nitrogen containing organics and inorganics. Moreover, the complete retardant package may contain more than one of these chemicals from more than one of the classes flame retardant materials including inorganics to take advantage of the different mechanisms for fire and flame suppression that are involved.

In the disclosed embodiments, a flame or fire retardant system may comprise a chemical, or mixture of chemicals, that reduce the ability of a material to ignite when in contact with a flame, or reduce the rate of combustion for an ignited material or cause the combustion to cease. Most commonly, a mixture of chemicals is used in order to take advantage of multiple, different mechanisms to protect the material. The chemicals that make up a flame or fire retardant system may be dissolved in, dispersed in or applied to the material to be protected, and in the case of tubular clays, even filled in an inner (e.g., inter-lumen) region of the tubes.

There is a synergistic improvement in flame retardance that is anticipated when halloysite is incorporated into composites which also contain halogenated organic, phosphoro-organic or nitrogen-organic flame retardant systems. The organics seem to be better dispersed and remain in the composite as temperature rises. Composites can be formed from halloysite that has been pretreated with polybromo organics, organo-phosphorous compounds or organo-nitrogen compounds or by adding the halloysite directly to the components to be compounded. If a pretreatment occurs the flame retardant organic material may be filling the lumen or simply loaded on the tube. It is possible that some of the organics are contained in the lumen and are released only when the sample becomes truly hot. Keeping these mobile organics off of the surface of the composite article or product and out of the environment is also a significant advantage for processing and final product use. Since they might be released on demand in the heat of a fire, the flame retardants organics, particularly the highly brominated compounds, will have less impact on the environment and may possibly be used in reduced amounts.

Nanocomposite objects including tubular clays can be formed by all of the commonly used methods of polymer fabrication. The following examples take advantage of the ability to melt and extrude or co-extrude the polymer/clay composite. These melt processes could of course be used to mold objects, make fibers, create foams, clad wires, form sheets, resin coat other media, etc. Sheets or fibers could then be stretched biaxially or uniaxially as appropriate. Composite objects can also be made from dispersions of the tubular clay within polymer latexes, dispersions or solutions. These solutions, dispersions or latexes can then be applied as coatings to fibers, woven objects, paper, plastic film, building materials (including wood, wallboard, etc.), metals, etc.

The advantages of the tubular clay-polymer composites disclosed herein are that they have improved flame and fire retardance as well as improved mechanical properties, as compared to the polymer matrix alone and to nanocomposites containing the polymer and platy clay, without adding large amounts of organic additives to the composite. It is further contemplated that a triggering mechanism or capability may be important. For example, it may be that heat or other mechanical or chemical “trigger” may be employed to release or initiate the availability of (e.g., elute) a flame or fire retardant material from the lumens of the tubes. It is also believed that there are synergistic relationships between the multiple elements which make up the flame retardant system. In other words, the use of halloysite nanotubes with other flame retardant materials is expected to improve the flame and fire retardant characteristics beyond what is demonstrated or expected from the use of the individual components.

The practice of one or more aspects of the invention are illustrated in more detail in the following non-limiting examples of materials that may be produced, including those in which halloysite may be dispersed into polymer base materials to produce nanocomposites for testing and characterization of fire and flame retardant characteristics. It will be appreciated that various levels and related ranges of halloysite nanotube fillers may be employed, both approximating and between the various filler levels described herein with respect to the following non-limiting Examples, with results comparable to those described below.

### EXAMPLES

The following experimental plan demonstrates the utility of tubular clays as improved fire and flame retardants. These clays are to be fabricated into composites along with other appropriate compounds and tested for flame and fire retardance. Five different classes of chemicals are to be investigated in various experiments, for example: polymers, clays, clay surface treatment, and both organic and inorganic flame and fire retardants. Four specific polymers were chosen to represent four very different classes of materials, process requirements and potential uses: Nylon 6 (N6), Polypropylene (PP), Polymethylmethacrylate (PMMA), and Polyethylene terephthalate (PET). It will be appreciated that the PMMA materials are know for the characterization of fire and flame retardant performance. Many other polymers and copolymers could have been chosen as described above including styrenics, epoxy resins, poly(lactic acid), poly(ethylene-co-vinyl acetate), etc. Two clays were chosen for study; a tubular clay, halloysite, and a commonly used platy clay, montmorillonite as a comparison material. Montmorillonite requires extensive organic treatment to allow it to be dispersed and therefore benzalkonium chloride is included as a primary treatment for both of the clays even though the treatment levels will be quite different since it is not required for the halloysite. Several reactive surface treatments using organosilanes are included in the experiment in order to look at improved performance due to improved interactions within the composite. A range of substituents attached to trialkoxysilane were evaluated to match and possibly react with the different types of polymers to be used. Substituents include, alkyl (octyl), alkenyl (vinyl), amino (aminopropyl), epoxy (glycidyl) and acrylate (methacryloylpropyl). Other organosilicone esters, organosilizanes and organotitanates are represented by these specific examples. Representatives of the halo-, phosphorous (P) and nitrogen (N) classes of organic flame and fire retardants are represented by decabromodiphenyl oxide (DECA), triphenyl phosphate (TPP) and melamine. The only example used of an inorganic flame retardant other than the clays themselves is vanadium oxide (V₂O₅) which is a strong synergist with many organic fire retardants. Other inorganic compounds of Al, Zn, B, Mo, P, etc. are believed to be equivalent alternatives and could have been used in the same manner.

It will also be appreciated that while one objective of the experimental plan is the characterization of flame and fire retardance in polymers, it is anticipated that similar improvements may be achieved when tubular clays, alone or in combination with other compounds, are included in other synthetic or natural materials or in material matrices. Thus, the present disclosure is also directed to the preparation and use of compositions or compounds that include tubular clays so as to improve fire and flame retardant characteristics of materials to which they are added. It is further contemplated that the presence of one or more fire or flame retardant materials may be achieved by coating and/or filling the tubular clay materials as suggested above.

The chemicals applied in the preparation of these materials were obtained from commercial sources. Halloysite clays were treated with quaternary alkylammonium salts by cation exchange, using a method similar to that described in Osman et. al. (M. A. Osman, M. Ploetze and U. W. Suter; J. Mater. Chem., 13, 2359-2366 (2003)) or were reacted with functionalized silylation agents in a pH adjusted alcohol water mixture as taught by Arkles (B. Arkles; Silane Coupling Agents: Connecting Across Boundaries; V2.0, copyright 2006). Halloysite clay (either treated or untreated) was mixed with other flame retardant materials in a Thinky mixer. All clay mixtures were dried at about 80° C. for about 60 minutes under reduced pressure before being fed into the extruder.

For the preparation of a polymer composite, a Thermo Fischer 16 mm Prism twin screw extruder was set up with two feed ports and two controlled feeders. In each of the following material compositions, the polymer will be fed in at the first station and after it reaches steady melt flow at the second station, the clay feed is begun at the second station. Single addition at the first station of a blended feed is also possible depending on the size and density of the two materials. The hot extrudate strand is then drawn through a water bath and into a rotary chopper to form 3 mm pellets that are generally cylindrical in their shape.

The pellets were then subjected to heat, melted and injection molded into conventional biscuit-shaped samples (“dog bones”) in a Thermo Fischer Haake MiniJet injector molder, or into other test shapes on a Morgan press. Physical/mechanical testing on the sample pieces is performed on a Tinius-Olsen testing machine and a TA Instruments 2980 Dynamic Mechanical Analyzer. Similarly shaped pieces will also be formed for the fire and flame test samples.

In summary, the preparation of composites may be generally represented by the following steps as described above:

1) Prepare formulations with material (e.g. polymer);

2) Obtain materials (e.g., polymers), clays, flame retardant chemicals;

3) Treat clays;

4) Combine and mix chemicals in a Thinky mixer;

5) Dry mixture using a vacuum oven;

6) Extrude samples to obtain pellets; and

7) Prepare (e.g., mold) test samples from the pellets.

The following represents an experimental plan, and examples of possible combinations of materials that are contemplated, for preparing various samples in the manner described above relative to polymer composite materials:

TABLE A

| polymer material | clay | clay treatment | flame retard 1 | flame retard 2 |
|---|---|---|---|---|
| pmma | none | none | none | none |
| pmma | montmorillonite | Q | none | none |
| pmma | montmorillonite | Q | deca | THA |
| pmma | montmorillonite | none | deca | THA |
| pmma | montmorillonite | Q | melamine | none |
| pmma | montmorillonite | Q | phosphate ester | none |
| pmma | halloysite | none | deca | THA |
| pmma | halloysite | none | none | none |
| pmma | halloysite | Q | none | none |
| pmma | halloysite | Q | deca | THA |
| pmma | halloysite | MA silane | deca | THA |
| pmma | halloysite | epox silane | deca | THA |
| pmma | halloysite | Q | melamine | none |
| pmma | halloysite | MA silane | melamine | none |
| pmma | halloysite | epox silane | melamine | none |
| pmma | halloysite | Amine silane | melamine | none |
| pmma | halloysite | Q | phosphate ester | none |
| pmma | halloysite | MA silane | phosphate ester | none |
| pmma | halloysite | epox silane | phosphate ester | none |
| pmma | none | none | deca | THA |
| PET | none | none | none | none |
| PET | none | none | deca | THA |
| PET | montmorillonite | Q | none | none |
| PET | montmorillonite | Q | deca | THA |
| PET | montmorillonite | none | deca | THA |
| PET | montmorillonite | Q | melamine | none |
| PET | montmorillonite | Q | phosphate ester | none |
| PET | halloysite | Q | none | none |
| PET | halloysite | none | deca | THA |
| PET | halloysite | Q | deca | THA |
| PET | halloysite | MA silane | deca | THA |
| PET | halloysite | epox silane | deca | THA |
| PET | halloysite | Q | melamine | none |
| PET | halloysite | MA silane | melamine | none |
| PET | halloysite | epox silane | melamine | none |
| PET | halloysite | Amine silane | melamine | none |
| PET | halloysite | Q | phosphate ester | none |
| PET | halloysite | MA silane | phosphate ester | none |
| PET | halloysite | epox silane | phosphate ester | none |
| polypropylene | none | none | none | none |
| polypropylene | none | none | deca | THA |
| polypropylene | montmorillonite | Q | none | none |
| polypropylene | montmorillonite | Q | deca | THA |
| polypropylene | montmorillonite | none | deca | THA |
| polypropylene | montmorillonite | Q | melamine | none |
| polypropylene | montmorillonite | Q | phosphate ester | none |
| polypropylene | halloysite | Q | none | none |
| polypropylene | halloysite | none | deca | THA |
| polypropylene | halloysite | Q | deca | THA |
| polypropylene | halloysite | MA silane | deca | THA |
| polypropylene | halloysite | epox silane | deca | THA |
| polypropylene | halloysite | Q | melamine | none |
| polypropylene | halloysite | MA silane | melamine | none |
| polypropylene | halloysite | epox silane | melamine | none |
| polypropylene | halloysite | Amine silane | melamine | none |
| polypropylene | halloysite | Q | phosphate ester | none |
| polypropylene | halloysite | MA silane | phosphate ester | none |
| polypropylene | halloysite | epox silane | phosphate ester | none |
| nylon | none | none | none | none |
| nylon | none | none | deca | THA |
| nylon | montmorillonite | Q | none | none |
| nylon | montmorillonite | Q | deca | THA |
| nylon | montmorillonite | none | deca | THA |
| nylon | montmorillonite | Q | melamine | none |
| nylon | montmorillonite | Q | phosphate ester | none |
| nylon | halloysite | Q | none | none |
| nylon | halloysite | none | deca | THA |
| nylon | halloysite | Q | deca | THA |
| nylon | halloysite | MA silane | deca | THA |
| nylon | halloysite | epox silane | deca | THA |
| nylon | halloysite | Q | melamine | none |
| nylon | halloysite | MA silane | melamine | none |
| nylon | halloysite | epox silane | melamine | none |
| nylon | halloysite | Amine silane | melamine | none |
| nylon | halloysite | Q | phosphate ester | none |
| nylon | halloysite | MA silane | phosphate ester | none |
| nylon | halloysite | epox silane | phosphate ester | none |
| nylon | halloysite | Amine silane | phosphate ester | none |

The flame and fire retardant characteristics of the nanocomposites may be determined using a cone calorimeter, by running the UL 94 vertical burning test and/or by determining the limiting oxygen index (LOI) using a FTA 710 oxygen analyzer from Stanton Redcroft according to ASTM D2863. It will also be appreciated that additional, product-specific, tests may be considered to determine flame and fire retardant characteristics of specific products that utilize the composite materials.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A fire and flame retardant composition, including:
a tubular clay; in combination with
a fire and flame retardant compound.

2. The fire and flame retardant composition according to claim 1, wherein the tubular clay includes halloysite nanotubes.

3. The fire and flame retardant composition according to claim 1, wherein the fire and flame retardant compound includes an organophosphate.

4. The fire and flame retardant composition according to claim 1, wherein the fire and flame retardant composition includes a polyhalogenated organic.

5. The fire and flame retardant composition according to claim 4, wherein the polyhalogenated organic includes decabromodiphenyl oxide.

6. The fire and flame retardant composition according to claim 1, wherein the fire and flame retardant compound includes an organophosphate and a metal oxide hydrate.

7. The fire and flame retardant composition according to claim 1, further including a polymer material such that the material and the fire and flame retardant composition provide a polymer composite.

8. The fire and flame retardant composition according to claim 1, further including a synthetic material.

9. The fire and flame retardant composition according to claim 1, further including a natural material.

10. The fire and flame retardant composition according to claim 1, wherein the fire and flame retardant compound includes an organic flame and fire retardant.

11. A method for producing a composite material, comprising mixing a tubular clay with a fire and flame retardant composition to improve the fire and flame retardant characteristics of the composition above that which is obtained without the tubular clay.

12. The method according to claim 11, wherein the tubular clay includes halloysite nanotubes.

13. The method according to claim 12, wherein the fire and flame retardant composition includes an organophosphate mixed with the halloysite nanotubes and added to a composite containing a metal oxide hydrate.

14. The method according to claim 11, wherein the fire and flame retardant composition includes a polyhalogenated organic.

15. The method according to claim 14, wherein the polyhalogenated organic includes a decabromodiphenyl oxide.

16. The method according to claim 11, wherein the fire and flame retardant composition is an organic material mixed with the halloysite nanotubes and added to a composite containing an inorganic material.

17. The method according to claim 11, further comprising adding the tubular clay with fire and flame retardant composition to a material matrix to produce a fire and flame retardant composite.

18. The method according to claim 17, wherein the material matrix includes a polymer.

19. A polymer composite comprising a polymer matrix and an inorganic filler, where the filler is a tubular clay and wherein the composite exhibits fire and flame retardant characteristics.

20. The composite according to claim 19, further comprising a fire or flame retardant system containing an organic selected from the group consisting of:
polyhalogenated organic;
a phosphorous containing organic; and
a nitrogen organic.

21. The composite according to claim 20, wherein the tubular clay includes halloysite nanotubes.

22. The composite according to claim 19, wherein the tubular clay includes halloysite nanotubes.

23. The composite according to claim 20, wherein at least one component of the fire or flame retardant system is at least partially incorporated within the tubular clay.

24. The composite according to claim 23, wherein the tubular clay includes halloysite nanotubes.

25. A fire and flame retardant polymer composite, comprising:
a polymer matrix, including a tubular clay filler; and
a polyhalogenated fire and flame retardant system.

26. The fire and flame retardant polymer composite according to claim 25, wherein said polyhalogenated fire and flame retardant system further comprises a polybrominated organic fire and flame retardant.

27. The fire and flame retardant polymer composite according to claim 25 wherein the tubular clay includes halloysite nanotubes.

28. The fire and flame retardant polymer composite according to claim 25 wherein the fire and flame retardant includes an organophosphate mixed with the halloysite nanotubes and added to a composite containing a metal oxide hydrate.

29. The fire and flame retardant polymer composite according to claim 25 wherein the fire and flame retardant includes a decabromodiphenyl oxide.

30. The method according to claim 25, wherein the fire and flame retardant composition is an organic material mixed with the halloysite nanotubes and added to a composite containing an inorganic material.

31. A fire and flame retardant polymer composite comprising a polymer matrix with a tubular clay filler in addition to a phosphorous-containing organic fire and flame retardant system.

32. The composite of claim 31 further comprising a hydrated inorganic filler.

33. The composite of claim 32, wherein said hydrated inorganic filler comprises trihydroxy alumina.
